(19) United States
(12) Patent Application Publication
(10) Pub. No.: US 2023/0274001 A1
(43) Pub. Date: Aug. 31, 2023

(54) OFF-HOST INTEGRITY VERIFICATION OF TRUSTED EXECUTION ENVIRONMENTS (TEEs)

(71) Applicant: Dell Products, L.P., Round Rock, TX (US)

(72) Inventors: John Boyle, Austin, TX (US); Ricardo L. Martinez, Leander, TX (US); Nicholas D. Grobelny, Evergreen, CO (US); Sudhakaran Jayakrishnan Venkateshaperumal, Austin, TX (US); Justin W. Johnson, Austin, TX (US); Golam Sarwar, Austin, TX (US)

(73) Assignee: Dell Products, L.P., Round Rock, TX (US)

(21) Appl. No.: 17/652,519

(22) Filed: Feb. 25, 2022

(51) Int. Cl. G06F 21/57; G06F 21/73; G06F 21/79

(52) U.S. Cl. CPC G06F 21/572; G06F 21/575; G06F 21/73; G06F 21/79

(57) ABSTRACT

Systems and methods for off-host integrity verification of Trusted Execution Environments (TEEs) are described. In some embodiments, an Information Handling System (IHS) may include a processor and a memory coupled to the processor, the memory having program instructions stored thereon that, upon execution, cause the IHS to obtain, by an Operating System (OS) agent, a measurement of contents of a selected area of a Non-Volatile Memory (NVM) used by a TEE coupled to the processor, transmit the measurement from the OS agent to another IHS configured to perform integrity verification of the TEE based, at least in part, upon the measurement, and receive, at the OS agent from the other IHS, an indication of a result of the integrity verification.

### FIELD

This disclosure relates generally to Information Handling Systems (IHSs), and, more specifically, to systems and methods for off-host integrity verification of Trusted Execution Environments (TEEs).

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Within an IHS, a Trusted Execution Environment (TEE) is a secure enclave having a secure processor or controller configured to execute its own Operating System (OS) with hardware isolation from other processors or controllers, such as a Central Processing Unit (CPU) or host processor. In some cases, a TEE may continue to operate so long as the IHS is receiving power. The TEE may have top level access to all IHS components, often completely bypassing the host OS. Examples of TEEs include INTEL's CONVERGED SECURITY AND MANAGEMENT ENGINE (CSME), AMD's PLATFORM SECURITY PROCESSOR (PSP), and ARM's TRUSTZONE, among others.

### SUMMARY

Systems and methods for off-host integrity verification of Trusted Execution Environments (TEEs) are described. In an illustrative, non-limiting embodiment, an Information Handling System (IHS) may include a processor and a memory coupled to the processor, the memory having program instructions stored thereon that, upon execution, cause the IHS to obtain, by an Operating System (OS) agent, a measurement of contents of a selected area of a Non-Volatile Memory (NVM) used by a TEE coupled to the processor, transmit the measurement from the OS agent to another IHS configured to perform integrity verification of the TEE based, at least in part, upon the measurement, and receive, at the OS agent from the other IHS, an indication of a result of the integrity verification.

The TEE may include at least one of: a Manageability Engine (ME), a Platform Security Processor (PSP), or an Embedded Controller (EC). The selected area may include at least one of: a Read-Only Memory (ROM) Boot Extension (RBE) area, a Bringup (BUP) area, or a Power Management Controller (PMC) area.

The program instructions, upon execution, may cause the IHS to receive, at the OS agent from an Original Equipment Manufacturer (OEM) of the IHS, an indication of an address range of the selected area. The address range of the selected area may be specific to at least one of: a model number, a serial number, or a service tag of the IHS.

The program instructions, upon execution, may also cause the IHS to receive, at the OS agent from an OEM of the IHS, an indication of a type of the measurement. The type of the measurement may include a hash value calculated based upon of at least a portion of the contents. To perform the integrity verification, the other IHS may be configured to compare the hash value against a reference hash value calculated based upon TEE instructions provided to the OEM by a manufacturer of the TEE.

In some cases, the TEE instructions may be delivered to the TEE in combination with a Basic/Input Output System (BIOS) update produced by the OEM, and the parser may be applied to the BIOS update to identify the TEE instructions. The TEE instructions may be delivered to the TEE in combination with the BIOS update as a single binary file.

The selected area may be identified, at least in part, via application of a parser to TEE instructions obtained by an OEM of the IHS from a manufacturer of the TEE. The program instructions, upon execution, may further cause the IHS to transmit the indication to a remote service configured to perform a security score assessment of the IHS based, at least in part, upon the indication.

In another illustrative, non-limiting embodiment, a memory storage device may have program instructions stored thereon that, upon execution by an IHS, cause the IHS to: calculate a hash value based upon contents of a RBE area, a BUP area, and a PMC area of a flash memory used by a ME coupled to a processor of the IHS, transmit the hash value to another IHS configured to perform integrity verification of the ME based, at least in part, upon the hash value, and receive, from the other IHS, an indication of a result of the integrity verification.

The RBE area, the BUP area, and the PMC area may be identified, at least in part, via application of a parser to ME instructions obtained by an OEM of the IHS from a manufacturer of the ME. The memory address of at least one of: the RBE area, the BUP area, or the PMC area may be selected by the OEM as corresponding to at least one of: a model number, a serial number, or a service tag of the IHS. The ME instructions may be delivered to the ME in combination with BIOS instructions produced the OEM as a binary file.

In yet another illustrative, non-limiting embodiment, a method may include receiving a hash value calculated by an IHS based upon contents of an RBE area, a BUP area, and a PMC area of a flash memory used by an ME coupled to the IHS, performing an integrity verification of the ME based, at least in part, upon a comparison between the hash value and a reference hash value, and transmitting an indication of a result of the integrity verification to the IHS.

The method may also include identifying memory addresses of the RBE area, the BUP area, and the PMC area, at least in part, via application of a parser to ME instructions obtained from a manufacturer of the ME. The memory addresses of the RBE area, the BUP area, or the PMC area may be specific to at least one of: a model number, a serial number, or a service tag of the IHS. The method may further include delivering the ME instructions to the ME in combination with BIOS instructions as a binary file.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a diagram depicting examples of components of an Information Handling System (IHS) configured to provide integrity verification of Trusted Execution Environments (TEEs), according to some embodiments.

FIG. 2 is a diagram of an example of a system configured to provide off-host integrity verification of TEEs, according to some embodiments.

FIG. 3 is a flowchart of an example of a method for providing off-host integrity verification of TEEs, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail below. It should be appreciated that although certain embodiments are discussed in the context of a personal computing device, other embodiments may utilize various other types of IHSs.

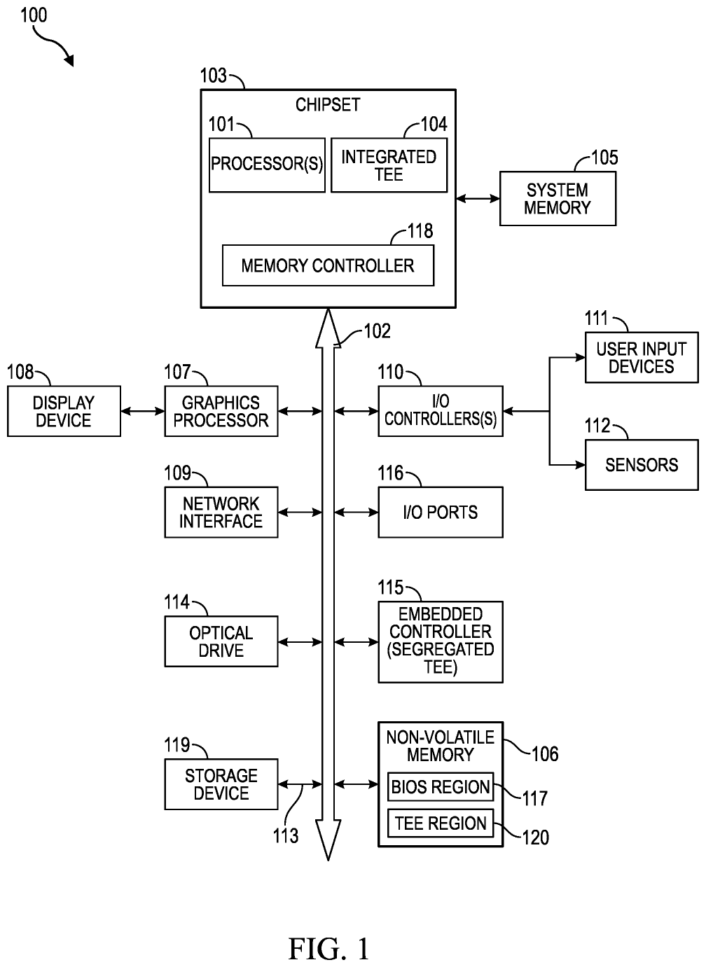

FIG. 1 is a diagram depicting components of an example IHS 100 configured to provide integrity verification of Trusted Execution Environments (TEEs). As shown, IHS 100 includes one or more processor(s) 101, such as a Central Processing Unit (CPU), operable to execute code retrieved from system memory 105. Although IHS 100 is illustrated with a single processor, other embodiments may include two or more processors, that may each be configured identically, or to provide specialized processing operations.

Processor(s) 101 may include any processor capable of executing program instructions, such as an INTEL PENTIUM series processor or any general-purpose or embedded processors implementing any of a variety of Instruction Set Architectures (ISAs), such as the x86, POWERPC®, ARM®, SPARC®, or MIPS® ISAs, or any other suitable ISA. Memory controller 118 may be implemented directly within the circuitry of processor(s) 101 or it may be a separate integrated circuit that is located on the same die as processor(s) 101. Memory controller 118 may be configured to manage the transfer of data to and from system memory 105 of IHS 100 via a high-speed memory interface.

System memory 105 is coupled to processor(s) 101 and provides processor(s) 101 with a high-speed memory that may be used in the execution of computer program instructions by processor(s) 101. For example, system memory 105 may include memory components such as such as Static RAM (SRAM), Dynamic RAM (DRAM), NAND Flash memory, or any other hardware memory device suitable for supporting high-speed memory operations by processor(s) 101. In various embodiments, system memory 105 may include any combination of re-writable, persistent memories, whether volatile or non-volatile.

Integrated Trusted Execution Environment (TEE) 104 may be a secure enclave having a secure processor or controller configured to execute a secure Operating System (OS) with hardware isolation from processor(s) 101. Examples of integrated TEEs include, but are not limited to, INTEL's CONVERGED SECURITY AND MANAGEMENT ENGINE (CSME), AMD's PLATFORM SECURITY PROCESSOR (PSP), ARM's TRUSTZONE, etc. In various implementations, TEE code 120 stored in Non-Volatile Memory (NVM) 106 may be accessible by chipset 103 via bus 102 and it may be usable by integrated TEE 104 to perform its regular operations. For example, NVM 106 may include a Serial Peripheral Interface (SPI) flash memory or the like. In addition, TEE code 120 may be usable to perform certain off-host integrity verification operations, as described herein.

IHS 100 utilizes chipset 103 (e.g., a Platform Controller Hub or “PCH,” a Fusion Controller Hub or “FCH,” etc.) having one or more integrated circuits coupled to processor(s) 101 and integrated TEE 104. In the embodiment of FIG. 1, processor(s) 101 and integrated TEE 104 are depicted as component(s) of chipset 103. In other embodiments, chipset 103 or portions thereof may be coupled to the integrated circuitry of processor(s) 101 and TEE 104. Chipset 103 provides processor(s) 101 and integrated TEE 104 with access to a variety of resources accessible via bus 102. In IHS 100, bus 102 is illustrated as a single element. However, other implementations may utilize any number of buses to provide the illustrated pathways served by bus 102.

As shown, a variety of resources may be coupled to processor(s) 101 and integrated TEE 104 through chipset 103. For instance, chipset 103 may be coupled to network interface 109, such as provided by a Network Interface Controller (NIC), to allow IHS 100 to communicate via a network, such as the Internet or a Local Area Network (LAN). Network interface 109 may provide IHS 100 with wired and/or wireless network connections via a variety of network technologies, such as wireless cellular or mobile networks (e.g., code-division multiple access “CDMA,” time-division multiple access or “TDMA,” Long-Term Evolution or “LTE,” etc.), WiFi, BLUETOOTH, etc.

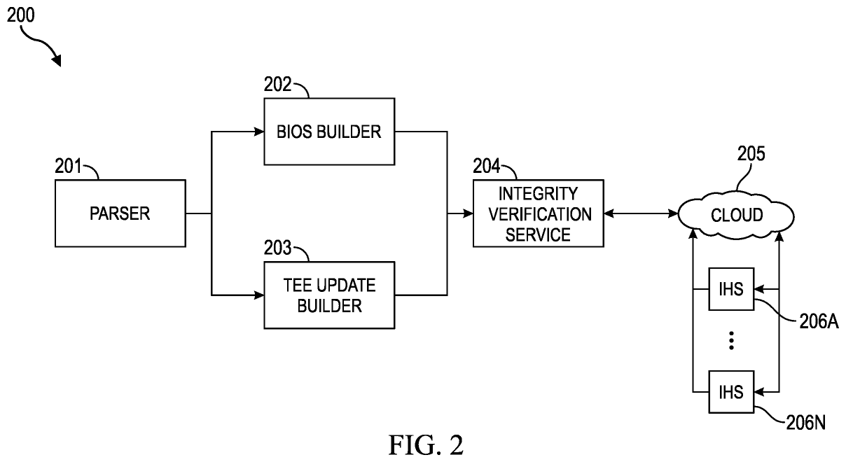

In certain embodiments, network interface 109 may support connections between a trusted IHS component, such as integrated TEE 104 or Embedded Controller (EC) 115, and a remote service (e.g., integrity verification service 204 of FIG. 2). In such embodiments, a connection supported by network interface 109 between the orchestration service and the trusted IHS component may be an out-of-band (00B) connection isolated from any OS of the IHS.

Chipset 102 may also provide access to one or more display device(s) 108 via graphics processor 107. In certain embodiments, graphics processor 107 may include a video or graphics card or controller configured to generate display information and to provide the generated information to one or more display device(s) 108.

Display device(s) 108 may utilize Liquid Crystal Display (LCD), Light Emitting Diode (LED), organic LED (OLED), or other thin film display technologies. Each of display device(s) 108 may be capable of touch input such as via a touch controller which may be an embedded component of display device(s) 108, graphics processor 107, or a separate component of IHS 100 accessed via bus 102.

In certain embodiments, chipset 103 may utilize one or more I/O controllers to access hardware components such as user input devices 111 and sensors 112. For instance, I/O controller 110 may provide access to user-input devices 110 such as a keyboard, mouse, touchpad, touchscreen and/or other peripheral input devices. User input devices 111 may interface with I/O controllers 110 through wired or wireless connections. Sensors 112 accessed via I/O controllers 110 may provide access to data describing environmental and operating conditions of IHS 100 (e.g., accelerometers, gyroscopes, hinge sensors, rotation sensors, hall effect sensors, temperature sensors, voltage sensors, sensors, IR sensors, photosensors, proximity sensors, distance sensors, magnetic sensors, microphones, ultrasonic sensors, etc.).

In some cases, chipset 103 may include a sensor hub capable of utilizing information collected by sensors 112 in determining the relative orientation and movement of IHS 100. For instance, the sensor hub may receive data obtained by inertial movement sensors, including accelerometers, gyroscopes, and/or magnetometer sensors, and it may determine the orientation and movement of IHS 100 based, at least in part, on that data (e.g., IHS 100 is motionless on a relatively flat surface, IHS 100 is being moved irregularly and is likely in transport, the hinge of IHS 100 is oriented in a vertical direction).

In certain embodiments, the sensor hub may also include capabilities for determining a location and movement of IHS 100 based on triangulation of network signals and/or based on network information provided by the OS and/or network interface 109. In some embodiments, the sensor hub may support additional sensors, such as optical, infrared and sonar sensors, that may provide support for xR (virtual, augmented, and/or mixed reality) sessions hosted by IHS 100 and that may be used to provide an indication of a user's presence near IHS 100, such as whether a user is present, absent, and/or facing integrated display 108.

In cases where the end-user is before IHS 100, the sensor hub may further determine a distance between the end-user and IHS 100. Such a determination may be made continuously, at periodic intervals, or upon request. These detected, calculated, or estimated distances may be used by processor(s) 101 to classify the user as being in IHS 100's near-field (user's position<threshold distance A), mid-field (threshold distance A<user's position<threshold distance B, where B>A), or far-field (user's position>threshold distance C, where C>B).

In embodiments where IHS 100 supports multiple physical configurations, such as a convertible laptop, N-in-1 device, or the like, the sensor hub may utilize one or more mode sensors 112 that collect readings usable to determine the posture in which IHS 100 is physically configured. In certain embodiments, posture determinations may be additionally made using movement and orientation information provided by sensors 112.

In laptop and convertible laptop embodiments, for example, processor(s) 101 or EC 115 may utilize a lid position sensor 112 to determine the relative angle between the two panels of the laptop to determine the mode in which IHS 100 is physically configured. For example, the lid position sensor may measure the angle of rotation of the hinge that connects the base panel and lid panel of IHS 100. In some cases, processor(s) 101 or EC 115 may provide collected lid position information, such as the hinge angle, to the sensor hub for use in determining the posture in which IHS 100 is configured. Alternatively, the sensor hub may interface directly with the lid position sensor in determining hinge angle information.

The sensor hub may determine the posture of IHS 100 based, at least in part, on the angle of rotation of the hinge of IHS 100 from a closed position. A first range of hinge angles from a closed position may indicate a laptop posture, a second range of hinge angles may indicate a landscape posture and a third range of angles may indicate a tablet posture. The sensor hub may additionally utilize orientation and movement information collected from inertial movement sensors 112 to further identify the posture in which IHS 100 is physically configured.

For instance, if the sensor hub determines that IHS 100 is configured with a hinge angle characteristic of a laptop configuration, but IHS 100 is oriented on its side, IHS 100 may be determined to be in a book posture. Additionally, or alternatively, if IHS 100 is determined to be tilted such that the hinge is oriented between horizontal and vertical, the user's face is detected to be facing the integrated display, and IHS 100 is experiencing slight movement, the sensor hub may determine that IHS 100 is being used in the book posture.

The sensor hub may determine that IHS 100 is opened to a 180-degree hinge angle and lies on a flat surface, thus indicating that IHS 100 it is being used in a landscape posture. The sensor hub may similarly determine that IHS 100 is in a tent posture, in response to detecting a hinge angle within a defined range, such as between 300 and 345 degrees, and detecting an orientation of IHS 100 where the hinge is aligned horizontally and is higher than both display panels of IHS 100.

Other components of IHS 100 may include one or more I/O ports 116 for communicating with peripheral external devices as well as various input and output devices. For instance, I/O 116 ports may include HDMI (High-Definition Multimedia Interface) ports for use in connecting external display devices to IHS 100 and USB (Universal Serial Bus) ports, by which a variety of external devices may be coupled to IHS 100. In some embodiments, external devices coupled to IHS 100 via I/O port 116 may include storage devices that support transfer of data to and from system memory 105 and/or storage devices 119 of IHS 100. Access to storage devices via I/O port 116 may result in a change in a security profile of IHS 100.

Chipset 103 also provides processor(s) 101 with access to one or more storage devices 119. In various embodiments, storage device 119 may be integral to IHS 100, or may be external to IHS 100. In certain embodiments, storage device 119 may be accessed via a storage controller that may be an integrated component of the storage device. Storage device 119 may be implemented using any memory technology allowing IHS 100 to store and retrieve data. For instance, storage device 119 may be a magnetic hard disk storage drive or a solid-state storage drive. In some embodiments, storage device 119 may be a system of storage devices, such as a cloud drive accessible via network interface 109.

IHS 100 also includes BIOS (Basic Input/Output System) code 117 stored in NVM 106 and accessible by chipset 103 via bus 102. Upon powering or restarting IHS 100, processor(s) 101 may utilize BIOS instructions 117 to initialize and test hardware components coupled to IHS 100. Upon execution, these instructions may facilitate the loading of an OS (e.g., WINDOWS, MACOS, iOS, ANDROID, LINUX, etc.) for use by IHS 100. BIOS 117 provides an abstraction layer that allows the OS to interface with hardware components of IHS 100. The Unified Extensible Firmware Interface (UEFI) was designed as a successor to BIOS. As a result, many IHS 100 may utilize UEFI in addition to or instead of a BIOS. As used herein, BIOS is intended to also encompass UEFI.

In addition, or as an alternative to integrated TEE 104, EC 115 may operate as a segregated TEE component coupled to the motherboard of IHS 100. In various implementations, TEE code 120 stored in NVM 106 may be usable by EC 115, as well as to perform certain off-host integrity verification operations described herein.

EC 115 may also implement operations for interfacing with a power adapter in managing power for IHS 100. Such operations may be utilized to determine the power status of IHS 100, such as whether IHS 100 is operating from battery power or is plugged into an AC power source. Firmware instructions utilized by EC 115 may be used to operate a secure execution environment that may include operations for providing various core operations of IHS 100, such as power management and management of certain modes of IHS 100 (e.g., turbo modes, maximum operating clock frequencies of certain components, etc.).

IHS 100 may support the use of various power modes. In some embodiments, the power modes of IHS 100 may be implemented through operations of EC 115 and/or the OS of IHS 100. In various embodiments, IHS 100 may support different reduced power modes to reduce power consumption and/or conserve battery power when IHS 100 is not actively in use, and/or to control a level of performance available to the user by increasing or decreasing a maximum operating clock frequency of a component of IHS 100 (e.g., processor(s) 101).

For example, in some implementations, a low-power mode of operation may include the S0 low-power idle model, also known as Modern Standby or Connected Standby, which provides an instant on/off user experience and maintains a network connection for certain processes while consuming very little power. These power modes may be entered, for example, when IHS 100 transitions into standby (e.g., “sleep,” etc.).

EC 115 may implement operations for detecting certain changes to the physical configuration of IHS 100 and managing the modes corresponding to different physical configurations of IHS 100. For instance, where IHS 100 is a laptop computer or a convertible laptop computer, EC 115 may receive inputs from a lid position sensor 112 that may detect whether the two sides of the laptop have been latched together to a closed position. In response to lid position sensor 112 detecting latching of the lid of IHS 100, EC 115 may initiate operations for shutting down IHS 100 or placing IHS 100 in a low-power mode.

In other embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components. For example, all or a portion of the operations executed by the illustrated components may instead be provided by components integrated into processor(s) 101 as systems-on-a-chip. As such, in certain embodiments, IHS 100 may be implemented as different classes of computing devices including, but not limited to: servers, workstations, desktops, laptops, appliances, video game consoles, tablets, smartphones, etc.

Typically, integrated TEE 104 (or segregated TEE 115) may be a small, low-power computer subsystem with significant execution privilege (e.g., Ring-3) that performs various tasks even while IHS 100 is powered off, in sleep, during the boot process, and when running. Because TEE 104 has top level access to all IHS components and completely bypasses the IHS 100's OS, it can be an attractive target for hackers.

In some cases, the manufacturer of TEE 104 may provide a utility application that runs on TEE 104 and allows TEE 104 to verify the integrity of its own program instructions. As the inventors hereof have recognized, however, allowing a potentially compromised component to perform its own verification is not always sufficient to ensure its integrity. As such, many customers often choose to “quiet” TEE 104 (or segregated TEE 115), which again usually cannot be completely shut down, to limit exposure to malicious attacks as much as possible.

To address these concerns, systems and methods discussed herein provide off-host integrity verification of TEE 104 (or segregated TEE 115) that ensure TEE 104 has been validated and has not been compromised. The verification operation may be securely performed by an entity other than TEE 104 itself (e.g., an off-host service), which allows customers to leverage the full potential of TEE 104 with peace of mind. Particularly, these systems and methods may verify, using off-host services and components, areas or regions of TEE code 120 (e.g., stored in NVM 106) selected as being critical for verification, in a targeted manner, to detect tampering and enable remediation while maintaining a high level of performance.

In various embodiments, an Original Equipment Manufacturer (OEM) of IHS 100 may assemble a “system build” for each IHS it produces. For example, a system build may include different firmware, such as TEE and BIOS instructions, which are combined or bundled together into a single file (e.g., a binary file) or image. Each IHS may have different components associated with a respective model number, serial number, service tag, or platform ID; therefore, the contents of each system build may differ from the next. Moreover, after an IHS leaves the OEM's factory, the OEM may send firmware updates to each IHS in response to BIOS updates, TEE updates, or any other component updates. As such, the same TEE instructions can change memory location from build to build, even if the TEE instructions themselves have not changed.

Using systems and methods described herein, when an OEM creates a system build for a particular IHS, an off-host TEE integrity verification tool or service may be used to check TEE measurements (e.g., hashes, signatures, certificates, etc.) before shipment of the IHS to verify that selected sub-regions of TEE code has not changed at any point in the customization process. The off-host TEE integrity verification service may then report its results to the OEM's manufacturing team.

Additionally, or alternatively, when the OEM performs customizations (i.e., “2^{nd} touch”) to an IHS after the IHS ships from a factory but before reaching a customer, for example, at an OEM's customization center, the off-host TEE integrity verification service may check measurements in the critical build upon receipt to verify that the TEE firmware has not been tampered with during shipment, as well as at final customization phase pre-ship. In this case, the off-host TEE integrity verification service may report its results to the OEM's customizations team.

Additionally, or alternatively, when the OEM receives an IHS from a customer to securely end-of-life the IHS or to securely reconfigure it, the off-host TEE integrity verification service may check measurements in the critical build upon receipt to verify that the TEE has not been tampered with during the lifecycle or shipment back to the OEM. In that case, the off-host TEE integrity verification service may report its results to the OEM's services team.

Additionally, or alternatively, any time an IT administrator would like to check if an IHS is compromised, the IT administrator may deploy and run the off-host TEE integrity verification service. The off-host TEE integrity verification service may check measurements for targeted components and verify that the contents of the TEE code have not changed. In this case, the off-host TEE integrity verification service may report its results to the IT administrator.

FIG. 2 is a diagram of an example of system 200 configured to provide off-host integrity verification of TEEs. In some embodiments, one or more components of system 200 may be implemented with one or more IHSs, such as IHS 100.

System 200 includes parser 201 provided by a manufacturer of TEE 104 (e.g., INTEL, AMD, ARM, etc.). In operation, parser 201 may be an application configured to identify the addresses of different portions of TEE code 120 stored in NVM 106. For example, in cases where TEE 104 is implemented as an ME or CSME device, the inventors hereof have identified three selected areas, portions, sections, regions, or sub-regions of ME firmware to be verified: the Read-Only Memory (ROM) Boot Extension (RBE) area, the Bringup (BUP) area, and the Power Management Controller (PMC) area.

Particularly, the RBE and BUP areas perform early-boot operations that assist in securely fetching and launching the ME main code, and the PMC area is responsible for sequencing hardware signals to correctly sequence voltage rails for chipset 103. In other TEE firmware implementations, parser 201 may allow an OEM to select target areas that perform similar operations as the RBE, BUP, and PMC areas. Moreover, parser 201 may also allow an OEM to select additional target areas for verification and to expand them to past and future IHS platforms, as required.

BIOS builder 202 receives BIOS instructions and TEE instructions, integrates TEE firmware and documents TEE's structure, and calculates reference hash values or signatures for these critical areas or sub-regions of firmware per system build release. Using parser 201, BIOS builder 202 may identify which address spaces of NVM 106 correspond to the selected areas of the firmware to be measured for purposes of verifying the integrity of TEE code 120 and to create a BIOS/TEE map file, which is then sent to integrity verification service 204. In other embodiments, TEE update builder 203 may be used instead of BIOS builder 202, which produces a TEE map file with the address spaces corresponding to the selected areas separate from the BIOS code.

Integrity verification service 204 receives an identification from each of clients 206A-N (e.g., model number, serial number, service tag, platform ID, etc.) over cloud 205 (e.g., the Internet), and responds with a list of memory addresses and size of each area to be measured. Each of clients 206A-N produces its measurements (e.g., hashes, signatures, etc.) and sends them to integrity verification service 204. In some cases, operations performed by clients 206A-N may be implemented by respective OS agents.

Integrity verification service 204 compares the received measurements against reference measurements to verify the integrity of the TEE code of each client 206A-N. Integrity verification service 204 may also be configured to update information per platform basis, and to update component information in multiple platforms. As a result, off-host, integrity verification service 204 may be the only entity of system 200 in possession of reference measurements, which need not be revealed to client 206A-N.

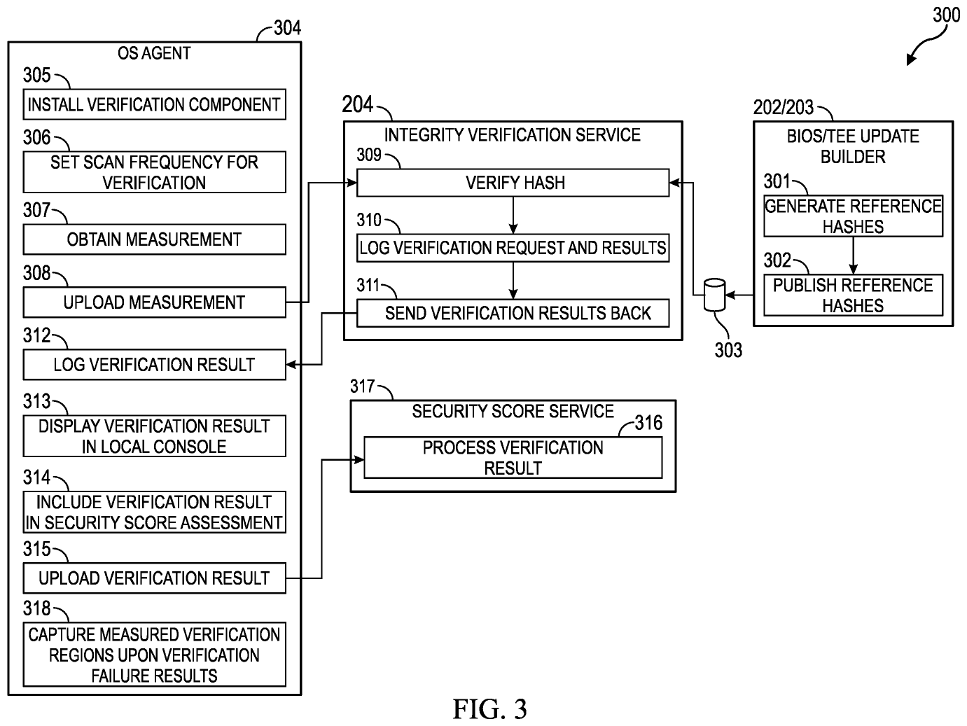

FIG. 3 is a flowchart of an example of method 300 for providing off-host integrity verification of TEEs. In various embodiments, method 300 may be performed by operation of system 200 and/or through the execution of program instructions used to implement components of system 200.

At 301, BIOS builder 202 (or TEE update builder 203) generates reference hashes or signatures for each area of TEE code selected for integrity verification for each OEM system build created for each platform (e.g., by model number, serial number, service tag, platform ID, etc.) using any suitable cryptographic technique. At 302, BIOS builder 202 (or TEE update builder 203) publishes those reference measurements onto reference measurement database 303.

Each of clients 206A-N includes an OS agent, such as OS agent 304, executed by a host processor (e.g., processor(s) 101). At 305, OS agent 304 installs a TEE integrity verification component in the IHS's host OS. At 306, OS agent 304 sets a scan frequency for TEE integrity verification operations (e.g., at every boot), for example, based upon user preferences or enterprise policies. In some cases, these scan frequencies may be selected and/or enforced via integrity verification service 204, other security service, or other update service.

At 307, OS agent 304 obtains one or more measurements (e.g., hashes, signatures, etc.) from TEE code 120 at address ranges corresponding to pre-selected areas thereof (e.g., RBE, BUP, PMC, etc.). In some cases, these address ranges may be unique to a given system build for a particular IHS, and therefore may be provided to OS agent 304 by integrity verification service 204 in anticipation of 307 (e.g., upon query by OS agent 304). Additionally, or alternatively, prior to 307 integrity verification service 204 may communicate to OS agent 304 an indication of a type of the measurement to be performed (e.g., a type of hash algorithm, etc.).

At 308, OS agent 304 uploads its measurement(s) to integrity verification service 204. At 309, integrity verification service 204 compares the uploaded measurement(s) against reference measurement(s) stored in reference measurement database 303 for that platform (e.g., identified by model number, serial number, service tag, platform ID, etc.). At 310, integrity verification service 204 logs the verification request from OS agent 304 as well as its results. At 311, integrity verification service 204 returns an indication of the results to OS agent 304.

At 312, OS agent 304 logs results of the verification received from integrity verification service 204. At 313, OS agent 304 displays results of the verification to a user or system administrator, for example, via a local console. At 314, OS agent 304 may include results of the verification in a security score assessment of IHS 100. At 315, OS agent 304 may upload results of the verification to security score service 317, which at 316 process the verification results in any manner suitable to produce security scores. At 318, in response to the results of the verification received at 312 indicating a failure indicative of tampering or compromise, OS agent 304 may capture the contents of the offending memory addresses for subsequent analysis.

As such, systems and methods described herein may provide below-the-OS security capabilities to identify TEE tampering and to enable remediation. Unlike other BIOS verification techniques, these systems and methods directly query TEE chips, not BIOS memories. Moreover, these systems and methods may provide: a consistent way to parse and read the critical firmware areas or sub-regions for the lifetime of the chipset, the ability to perform validation on platforms during system validation and compare against hash values and signatures generated at build time, and the ability to perform preventative validation at any stage of the digital supply chain process, from assembly through end-of-life of the device.

To implement various operations described herein, computer program code (i.e., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

In many implementations, systems and methods described herein may be incorporated into a wide range of electronic devices including, for example, computer systems or Information Technology (IT) products such as servers, desktops, laptops, memories, switches, routers, etc.; telecommunications hardware; consumer devices or appliances such as mobile phones, tablets, wearable devices, IoT devices, television sets, cameras, sound systems, etc.; scientific instrumentation; industrial robotics; medical or laboratory electronics such as imaging, diagnostic, or therapeutic equipment, etc.; transportation vehicles such as automobiles, buses, trucks, trains, watercraft, aircraft, etc.; military equipment, etc. More generally, these systems and methods may be incorporated into any device or system having one or more electronic parts or components.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a processor; and
a memory coupled to the processor, the memory having program instructions stored thereon that, upon execution, cause the IHS to:
obtain, by an Operating System (OS) agent, a measurement of contents of a selected area of a Non-Volatile Memory (NVM) used by a Trusted Execution Environment (TEE) coupled to the processor;
transmit the measurement from the OS agent to another IHS configured to perform integrity verification of the TEE based, at least in part, upon the measurement; and
receive, at the OS agent from the other IHS, an indication of a result of the integrity verification.

2. The IHS of claim 1, wherein the TEE comprises at least one of: a Manageability Engine (ME), a Platform Security Processor (PSP), or an Embedded Controller (EC).

3. The IHS of claim 1, wherein the selected area comprises at least one of: a Read-Only Memory (ROM) Boot Extension (RBE) area, a Bringup (BUP) area, or a Power Management Controller (PMC) area.

4. The IHS of claim 1, wherein the program instructions, upon execution, further cause the IHS to receive, at the OS agent from an Original Equipment Manufacturer (OEM) of the IHS, an indication of an address range of the selected area.

5. The IHS of claim 4, wherein address range of the selected area is specific to at least one of: a model number, a serial number, or a service tag of the IHS.

6. The IHS of claim 1, wherein the program instructions, upon execution, further cause the IHS to receive, at the OS agent from an Original Equipment Manufacturer (OEM) of the IHS, an indication of a type of the measurement.

7. The IHS of claim 6, wherein the type of the measurement comprises a hash value calculated based upon of at least a portion of the contents.

8. The IHS of claim 7, wherein to perform the integrity verification, the other IHS is configured to compare the hash value against a reference hash value calculated based upon TEE instructions provided to the OEM by a manufacturer of the TEE.

9. The IHS of claim 8, wherein the TEE instructions are delivered to the TEE in combination with a Basic/Input Output System (BIOS) update produced by the OEM, and wherein the parser is applied to the BIOS update to identify the TEE instructions.

10. The IHS of claim 8, wherein the TEE instructions are delivered to the TEE in combination with the BIOS update as a single binary file.

11. The IHS of claim 1, wherein the selected area is identified, at least in part, via application of a parser to TEE instructions obtained by an Original Equipment Manufacturer (OEM) of the IHS from a manufacturer of the TEE.

12. The IHS of claim 1, wherein the program instructions, upon execution, further cause the IHS to transmit the indication to a remote service configured to perform a security score assessment of the IHS based, at least in part, upon the indication.

13. A memory storage device having program instructions stored thereon that, upon execution by an Information Handling System (IHS), cause the IHS to:
calculate a hash value based upon contents of a Read-Only Memory (ROM) Boot Extension (RBE) area, a Bringup (BUP) area, and a Power Management Controller (PMC) area of a flash memory used by a Manageability Engine (ME) coupled to a processor of the IHS;
transmit the hash value to another IHS configured to perform integrity verification of the ME based, at least in part, upon the hash value; and
receive, from the other IHS, an indication of a result of the integrity verification.

14. The memory storage device of claim 13, wherein the RBE area, the BUP area, and the PMC area are identified, at least in part, via application of a parser to ME instructions obtained by an Original Equipment Manufacturer (OEM) of the IHS from a manufacturer of the ME.

15. The memory storage device of claim 14, wherein a memory address of at least one of: the RBE area, the BUP area, or the PMC area is selected by the OEM as corresponding to at least one of: a model number, a serial number, or a service tag of the IHS.

16. The memory storage device of claim 14, wherein the ME instructions are delivered to the ME in combination with Basic/Input Output System (BIOS) instructions produced the OEM as a binary file.

17. A method, comprising:
receiving a hash value calculated by an Information Handling System (IHS) based upon contents of a Read-Only Memory (ROM) Boot Extension (RBE) area, a Bringup (BUP) area, and a Power Management Controller (PMC) area of a flash memory used by a Manageability Engine (ME) coupled to the IHS;
performing an integrity verification of the ME based, at least in part, upon a comparison between the hash value and a reference hash value; and
transmitting an indication of a result of the integrity verification to the IHS.

18. The method of claim 17, further comprising identifying memory addresses of the RBE area, the BUP area, and the PMC area, at least in part, via application of a parser to ME instructions obtained from a manufacturer of the ME.

19. The method of claim 18, wherein the memory addresses of the RBE area, the BUP area, or the PMC area are specific to at least one of: a model number, a serial number, or a service tag of the IHS.

20. The method of claim 19, further comprising delivering the ME instructions to the ME in combination with Basic/Input Output System (BIOS) instructions as a binary file.
